(19) United States
(12) Patent Application Publication
(10) Pub. No.: US 2010/0175022 A1
(43) Pub. Date: Jul. 8, 2010

(54) USER INTERFACE

(75) Inventors: William Diehl, Dove Canyon, CA (US); Stephanie Lynn Otto, Lake Oswego, OR (US); Richard Mark Reisman, Rancho Santa Margarita, CA (US)

Correspondence Address: HAYNES AND BOONE, LLP;IP Section, 2323 Victory Avenue, Suite 700, Dallas, TX, 75219, US

(73) Assignee: CISCO TECHNOLOGY, INC., San Jose, CA (US)

(21) Appl. No.: 12/684,063

(22) Filed: Jan. 7, 2010

Related U.S. Application Data
(60) Provisional application No. 61/143,080, filed on Jan. 7, 2009.

(51) Int. Cl. G06F 3/048

(52) U.S. Cl. 715/784; 715/811; 715/764; 715/805

(57) ABSTRACT

In one embodiment, an apparatus comprises a communication interface for receiving content from a content source, a display interface for coupling to a display, a processor for manipulating the content in a form so that it can be transmitted over the display interface and presented on the display, a memory coupled to the processor for storing instructions to implement a user interface, the user interface being operable for navigating the content, and a user input section for receiving input from a user. The processor is operable to present the user interface on the display and dynamically change the user interface as at least one of an amount of content changes or the frequency of selecting content by the user changes.

### PRIORITY DATA

This application claims priority to U.S. provisional patent application Ser. No. 61/143,080, titled, “HALO USER GUIDE”, filed Jan. 7, 2009, the disclosure of which is incorporated herein by reference.

### TECHNICAL FIELD

The present disclosure relates generally to a user interface.

### BACKGROUND

Data and voice communication is converging. Frequently there are many sources of data. Some of the sources are local to a user that experiences the content, while some of the sources are remote to the user. Moreover, different communication protocols and methods are employed for communicating the content to the user. Management of content is increasingly important. For example, managing sources of content, managing accessibility of content to provide appropriate conditional access rights and security is also important. Further, personalization of the content, interactive services, and premium content is also becoming prevalent and desirable.

An approach that embraces multiple sources for converging content to the user is desirable. Moreover, extending sources of content that may be remote or local to a user is also desirable. An intelligent user interface that allows a user to seamlessly access content from different sources is desirable.

### BRIEF DESCRIPTION OF THE DRAWINGS

FIG. 1 is an example system in which various embodiments disclosed herein may be implemented.

FIG. 2 is an example block diagram of a digital media adapter shown in FIG. 1.

FIG. 3 is an example diagrammatic representation of a remote control shown in FIG. 1.

FIG. 4 is an example diagrammatic representation of a user interface that may be displayed on a display shown in FIG. 1.

FIG. 5 is another example diagrammatic representation of the user interface that may be displayed on the display shown in FIG. 1.

FIG. 6 is another example diagrammatic representation of the user interface that may be displayed on the display shown FIG. 1.

FIG. 7 is another example diagrammatic representation of the user interface that may be displayed on the display shown in FIG. 1.

FIG. 8 is an example diagrammatic representation of the user interface that may be partially displayed on the display shown in FIG. 1.

FIG. 9 is an example diagrammatic representation of the user interface that may be displayed on the display shown in FIG. 1.

FIG. 10 is another example diagrammatic representation of the user interface that may be displayed on the display shown in FIG. 1.

FIG. 11 is another example diagrammatic representation of the user interface that may be displayed on the display shown in FIG. 1.

FIG. 12 is another example diagrammatic representation of the user interface that may be partially displayed on the display shown in FIG. 1.

FIG. 13 is another example diagrammatic representation of the user interface that may be partially displayed on the display shown in FIG. 1.

FIG. 14 is another example diagrammatic representation of the user interface that may be partially displayed on the display shown in FIG. 1.

FIG. 15 is an example flowchart of a method that may be implemented in the system of FIG. 1.

### DESCRIPTION

### Overview

An apparatus comprises a communication interface for receiving content from a content source, a display interface for coupling to a display, a processor for manipulating the content in a form so that it can be transmitted over the display interface and presented on the display, a memory coupled to the processor for storing instructions to implement a user interface, the user interface being operable for navigating the content, and a user input section for receiving input from a user. The processor is operable to present the user interface on the display and dynamically change the user interface as at least one of an amount of content changes or the frequency of selecting content by the user changes.

An apparatus comprising a tangible computer-readable storage structure storing a computer program that, when executed: processes an input received by a user, receives content from a content source, manipulates the content in a form so that it can be transmitted to a display, presents a user interface on the display, the user interface operable to allow the user to navigate the content, and dynamically changes the user interface as at least one of an amount of content changes or the frequency of selecting content by the user changes.

An apparatus comprising a communication interface for receiving content from a content source, a display interface for coupling to a display, a processor for manipulating the received content in a form so that it can be transferred by the display interface to the display for presentation on the display, a user input section for receiving input from a user, a memory coupled to the processor for storing instructions that are operated by the processor to present a user interface on the display, the user interface being operable for navigating the content from the content source. In a first operational state the user interface includes a portion of a carousel that is bound by first and second arcs, one of the first and second arcs having a radius that is greater than the other of the first and second arc, the portion of the carousel being visibly present on the display and having a plurality of visual cues for navigating the content from the source, and in a second operational state the user interface includes a second portion of the carousel that is visibly present on the display, the second portion including a subset of the first portion and being bound by a side of the display and one of the first and second arcs. In response to user input received by the interface, the processor is operable to change between the first and second operational states of the user interface that is presented on the display.

A method comprising processing an input received by a user, receiving content from a content source, manipulating the content in a form so that it can be transmitted to a display, presenting a user interface on the display, the user interface operable to allow the user to navigate the content, and dynamically changing the user interface as at least one of an amount of content changes or the frequency of selecting content by the user changes.

### DESCRIPTION OF EXAMPLE EMBODIMENTS

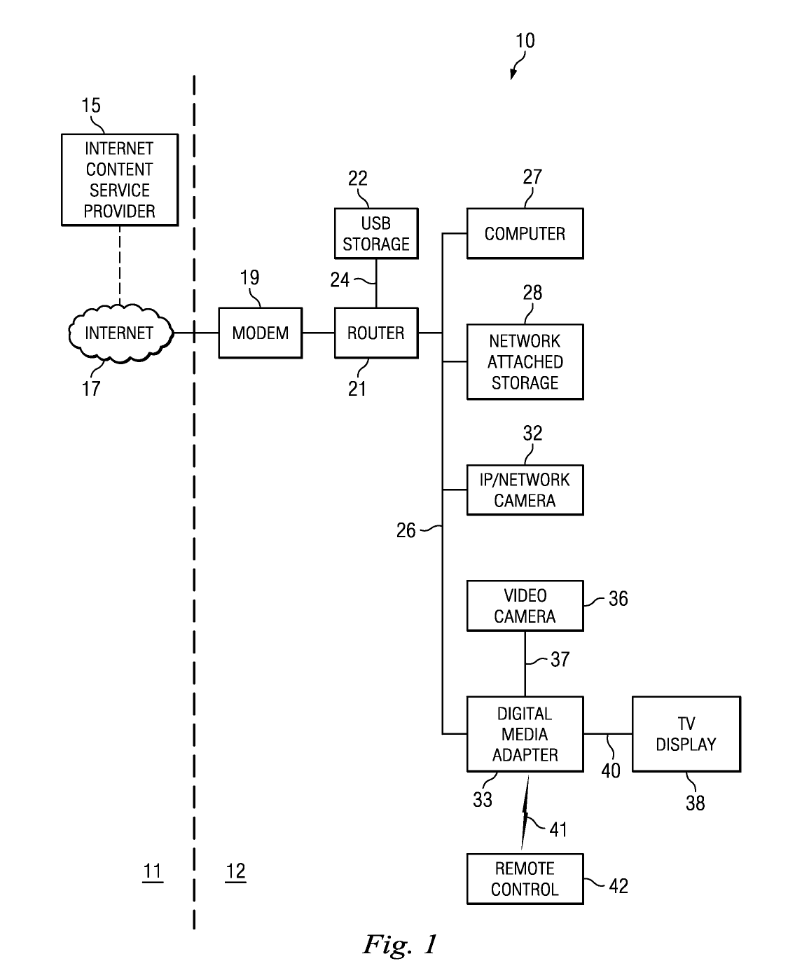

FIG. 1 is an example system 10 in which various embodiments disclosed herein may be implemented. The system 10 may include a wide area network (WAN) 11 and a local area network (LAN) 12. The WAN 11 may include an internet content service provider 15 and the internet 17. The internet content service provider 15 may be connected to the internet 17. The internet 17 may be further connected to the LAN 12.

The LAN 12 may reside in a home in a residential area. Alternatively, the LAN 12 may reside in an office building or other commercial area. The LAN 12 may include a modem 19 that is connected to the internet 17. The modem may be further coupled to a router 21. The router 21 may be coupled to a universal serial bus (USB) storage device 22 over a USB communication link 24. The USB storage device 22 may include content that can be accessed by other components in the system 10. The router 21 may also be connected to a network communication bus 26 that is an Ethernet™ communication bus. Alternatively, the network communication bus may comprise powerline wiring or may use a wireless communication protocol such as 802.11. The router 21 may include a media server (not shown) for sharing content from the USB storage device. A computer 27 may be connected to the Ethernet™ bus 26. The computer 27 may include content and a media server (not shown) that provides content to other components in the system 10. Moreover, a network attached storage (NAS) device 28 may also be coupled to the Ethernet™ bus 26. The NAS device 28 may include content and a media server (not shown) that provides content to other components in the system 10. Further, an internet phone (IP) network camera 32 may be connected to the network bus 26. The IP network camera 32 may include content and a media server (not shown) that provides content to other components in the system 10. In addition, a digital media adapter (DMA) 33 may be connected to the network bus 26. The DMA 33 may access content from components in the system 10. For example, the DMA 33 may access content from the router 21, the USB storage device 22, the computer 27, the NAS device 28, and the IP network camera 32.

The DMA 33 may be coupled to a video camera 36 over a USB communication link 37. Alternatively, the communication link between the video camera 36 and the DMA 33 may use a proprietary connection. The DMA 33 may include a media server (not shown) for sharing content from the video camera 36. The DMA 33 may be further connected to a television (TV) display 38. Alternatively, the display may comprise another type of display such as a liquid crystal display (LCD) monitor. The TV display 38 may include a high definition multimedia interface (HDMI) connector. The DMA 33 may be connected to the TV display 38 over an audio/video (A/V) communication link 40 that supports the high definition multimedia interface (HDMI) standard. The DMA 33 may provide information that is displayed on the TV display 38 so that content may be experienced in audio or video, or a combination thereof. Alternatively or in addition, the TV display 38 may include component, composite, and audio connectors for receiving audio and video from the DMA 33. Alternatively, the communication link between the DMA 33 and the TV display 38 may comprise a different type of A/V connection such as component, composite, S-video, etc.

The DMA 33 may be coupled over a radio frequency (RF) communication link 41 to a remote control 42. Alternatively, the communication link 41 may be an infrared (IR) communication link or a proprietary communication link Features of the remote control 42 that are relevant to the embodiments herein disclosed are explained in more detail later. The remote control 42 may control the DMA 33.

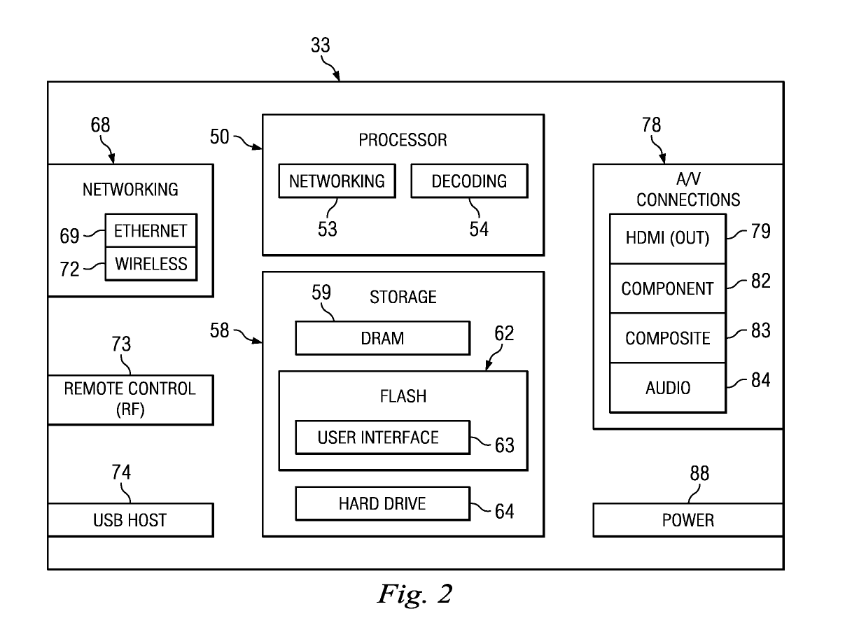

FIG. 2 is an example block diagram of the DMA 33 shown in the example system 10 of FIG. 1. FIG. 2 does not show all the interconnections between components of the DMA 33. FIG. 2 is a non-exhaustive example functional block diagram of components in the DMA 33 that provide a better understanding of the embodiments herein disclosed. The DMA 33 may include a processor 50. The processor 50 may include a networking component 53 and a decoding component 54. The networking component 53 may handle processing associated with networking the DMA 33 to devices in the system 10 of FIG. 1. The decoding component 54 may handle processing associated with decoding necessary for various type of digital content that is transferred in the example system 10.

The DMA 33 may further include a storage section 58. The storage section 58 may include a dynamic random access memory (DRAM). The storage section 50 may also include flash memory 62. The flash memory 62 may store instructions for implementing a user interface. Further details of the user interface are provided later. Moreover, the storage 50 may include a hard drive 58.

In addition, the DMA 33 may include a networking section 68 that is a communication interface. The networking section 68 may include an Ethernet portion 69. In general, the Ethernet portion 69 may allow the DMA 33 to communicate with other devices in the LAN 12 of FIG. 1. As an example, the Ethernet portion 69 may provide the ability for the DMA 33 to communicate on the Ethernet bus 26. The networking section 68 may further include a wireless portion 72. The wireless portion 72 may allow the DMA 33 to communicate with wireless devices in the LAN 12 (FIG. 1). For example, the wireless portion 72 may support the wireless communication protocol 802.11. Alternatively, the wireless portion 72 may support other wireless communication protocols, including proprietary protocols.

The DMA 33 may include an RF remote control section 73 that is a user input section. The remote control section 73 may allow the DMA 33 to receive control signals from the remote control 42 in the LAN 12 shown in FIG. 1. Further, the DMA 33 may include a USB host 74. The USB host 74 may allow the DMA 33 to communicate with other devices in the LAN 12 using the USB protocol standard. As an example, the USB host 74 may allow the DMA 33 to communicate with the video camera 36 over the USB communication link 37.

Further, the DMA 33 may include an A/V connections section 78 that is a display interface. The A/V connections section 78 may include an HDMI out portion 79. The HDMI out portion 79 may allow for the DMA 33 to output audio and video in a digital format to a device in the LAN 12 (FIG. 1). As an example, the HDMI portion 79 may be connected to the HDMI communication link that is coupled to the TV display 38. Moreover, the A/V connections section 78 may include a component video portion 82. The component video portion 82 may output video in component video format. The component video portion 82 may include a connector (not shown) for connecting the component video portion 82 to a display such as the TV display 38 shown in the LAN 12 of FIG. 1. Further, the A/V connections section 78 may include a composite video portion 83. The composite portion 83 may output video in composite form to a display such as the TV display 38 shown in the LAN 12 of FIG. 1. The A/V connections section 78 may include an audio portion 84. The audio portion 84 may output audio. The audio portion 84 may include an audio connector (not shown) for connecting the audio to a device for presenting audio to a user, such as the TV display 38 shown in the LAN 12 of FIG. 1.

In addition, the DMA 33 may include a power supply section 88. The power supply section 88 may include a connector (not shown) for receiving alternating current (AC) power from an AC power outlet and may regulate that power into direct current (DC) power that may be supplied to the different sections of the DMA 33. Alternatively, the power supply section may be designed to receive power from an alternative source. As an example, the power supply may be designed to receive power from an Ethernet connection that also transmits power.

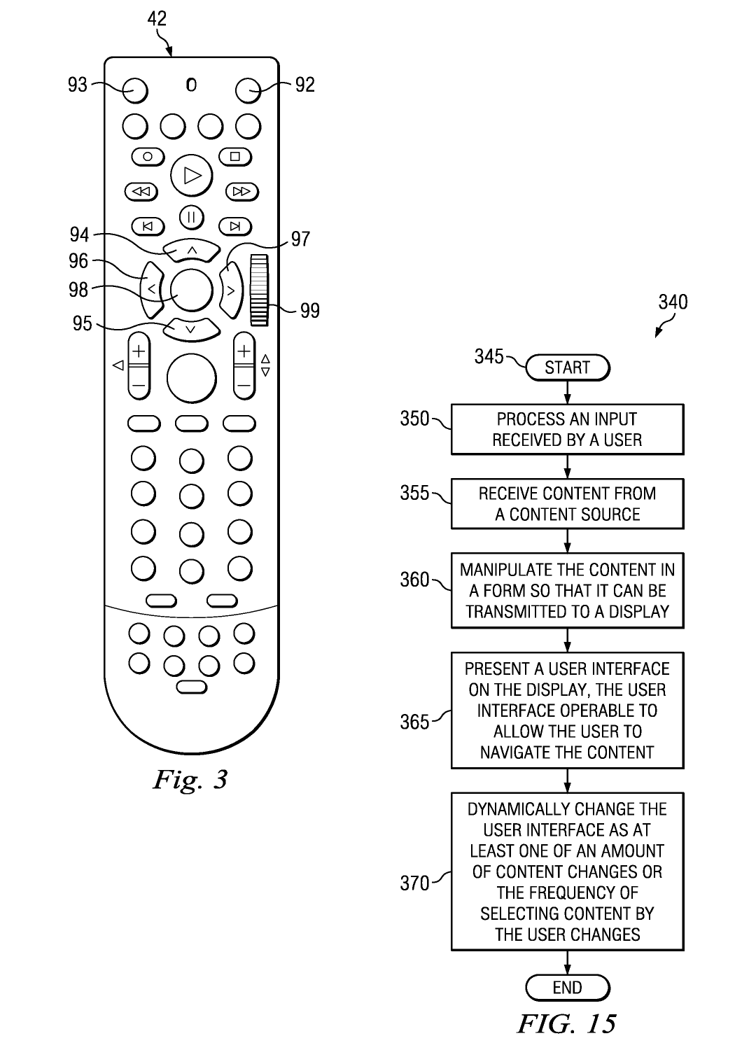

FIG. 3 is an example diagrammatic representation of the remote control 42 that is shown in the LAN 12 of FIG. 1. Not all features of the remote control 42 will be explained. The description that follows describes features of the remote control for providing a better understanding of the embodiments herein disclosed. In general, the remote control 42 may communicate with the DMA 33 (FIG. 1) using RF wireless communication. The remote control 42 may allow a user to control the DMA 33. In that regard, the remote control 42 may include a power button 92. The power button turns on and off the DMA 33. Moreover, the DMA may include a menu button 93. The menu button may display a user interface on the TV display 38. The user interface will be described in more detail later. The remote control 42 may include an up arrow 94, a down arrow 95, a left arrow 96, and a right arrow 97. The navigational arrows 94-97 may allow a user to navigate the user interface that is displayed when the menu button 93 is selected. The remote control may also include a selection button 98 for allowing a user to select a feature that is displayed on the user interface and TV display 38. In addition, the remote control 42 may include a scroll wheel 99. The scroll wheel may provide an interactive scrolling feature on the display 38. The scrolling feature may enable accelerated navigation of content that is displayed on the TV display 38. For example, a user may activate the interactive scroll wheel navigation by pressing the scroll wheel 99 and the user may deactivate the interactive scroll wheel navigation by again pressing the scroll wheel 99. The user may navigate through the interactive scroll displayed on the TV display 38 by turning the scroll wheel 99 on the remote control 42. Greater detail about the interactive scrolling feature is provided later.

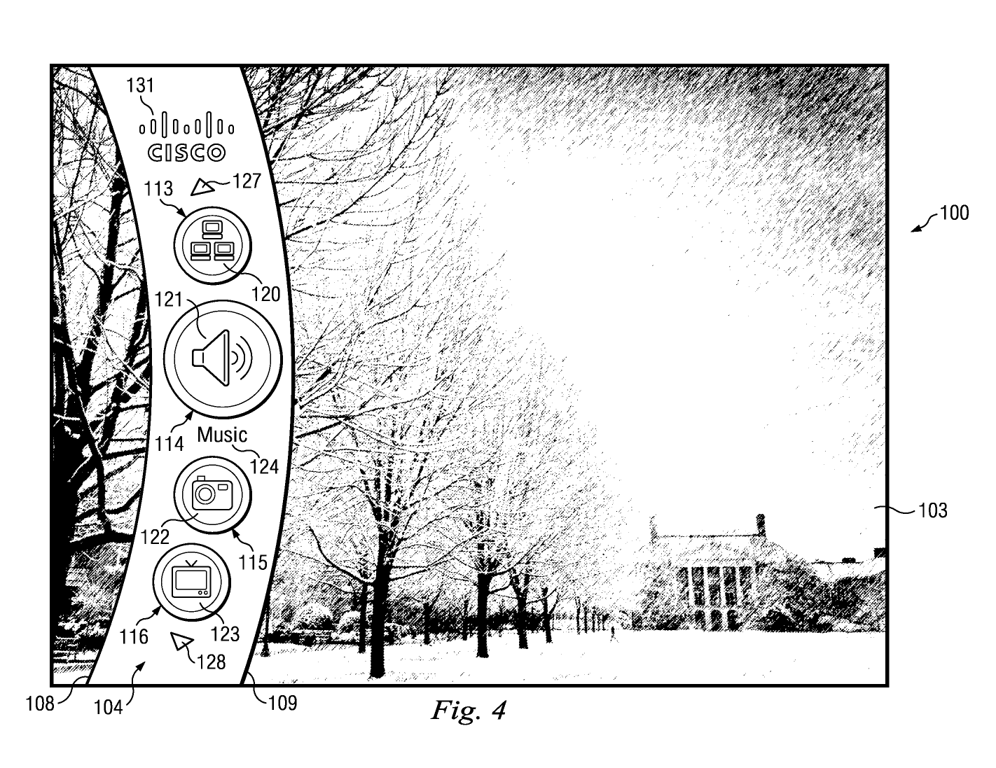

FIG. 4 is an example diagrammatic representation of a user interface 104 that may be displayed along with multimedia content 103 on the TV display 38 shown in the LAN 12 of FIG. 1. For example, the user interface 104 may include an inner border 108 and an outer border 109. The inner and outer borders 108 and 109 may be semicircles having a similar center and different radius. Thus, the user interface 104 appears as a portion of a carousel. The user interface 104 may include icons 113-116. The icon 114 may be larger than the other icons 113, 115 and 116. In that regard, the larger icon 114 may illuminate the image therein for the user to more easily navigate through the user interface 104. Each of the icons 114-116 may include a different image (visual cue) that may change as a user navigates using the interface 104. For example, in the state shown in FIG. 4 the icon 114 may include an image 120 that depicts sources. The icon 114 may include an image 121 that depicts the category “Music.” The image 121 may be larger in size than the images 113, 115, and 116. The icon 115 may include an image 122 that depicts “Photos” and the icon 116 may include an image 123 that depicts “Video.” The images 120-123 (“Sources,” “Music,” “Photos,” and “Video”) are visual cues that are visible on the user interface 104 and therefore are visible visual cues.

To further aid a user's navigation, the user interface 104 may include a navigational indicator 124 adjacent to the icon 114. For example, in the state shown in FIG. 4, the navigational indicator 124 may alphabetically indicate the category that may be represented by the image 121. For example, the navigational indicator 124 in the state shown in FIG. 4 may show the word “Music.” The user interface 104 may also include arrows 127 and 128. The arrows 127 and 128 are subtle graphic indicators that the user may navigate up or down to transition the images up or down the user interface 104.

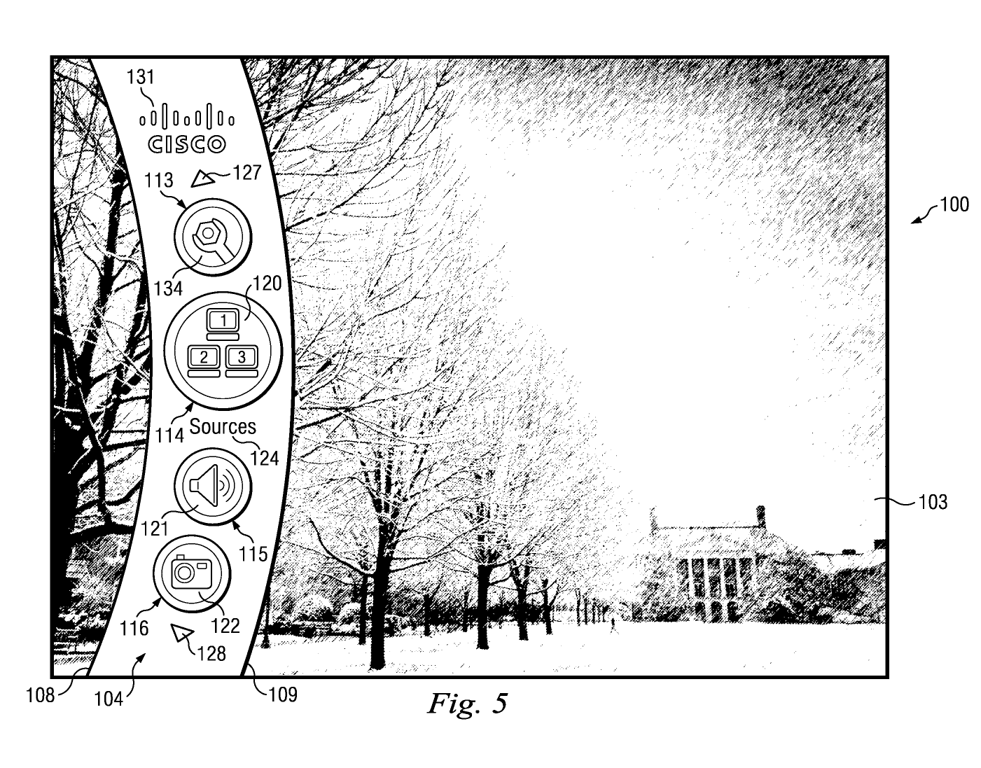

FIG. 5 is an example diagrammatic representation of the user interface 104 that may be displayed along with multimedia content 103 on the TV display 38 shown in the LAN 12 of FIG. 1, and illustrating the user interface 104 in a different state than the state shown in FIG. 4. Similar features in FIGS. 4 and 5 are numbered the same for the sake of clarity and simplicity. Moreover, the following discussion focuses primarily on the differences. In the state shown in FIG. 5, the icon 113 may include an image 134 that depicts “Settings.” The icon 114 may include the image 120 that depicts “Sources.” Moreover, the navigational indicator 124 that is adjacent to the icon 114 may indicate that the category represented by the image 133 is “Sources.” Further, the icon 115 may include the image 121 that depicts “Music.” In addition, the icon 116 may include the image 122 that depicts “Photos.”

The images 134, 120-122 (“Settings,” “Sources,” “Music,” and “Photos”) are visual cues that are visible on the user interface 104 and therefore are visible visual cues. As compared to the state of the user interface shown in FIG. 4, the state of the user interface shown in FIG. 5 omits the image 123 (“Video”) and adds the image 134 (“Settings”). In other words, the group of visible images displayed on the state of the user interface 104 shown in FIG. 5 includes at least one image (134, “Settings”) that is free from the group of images displayed on the state of the user interface 104 shown in FIG. 4. Likewise, the group of visible images displayed on the state of the user interface 104 shown in FIG. 4 includes at least one image (122, “Photos”) that is free from the group of images displayed on the state of the user interface 104 shown in FIG. 5.

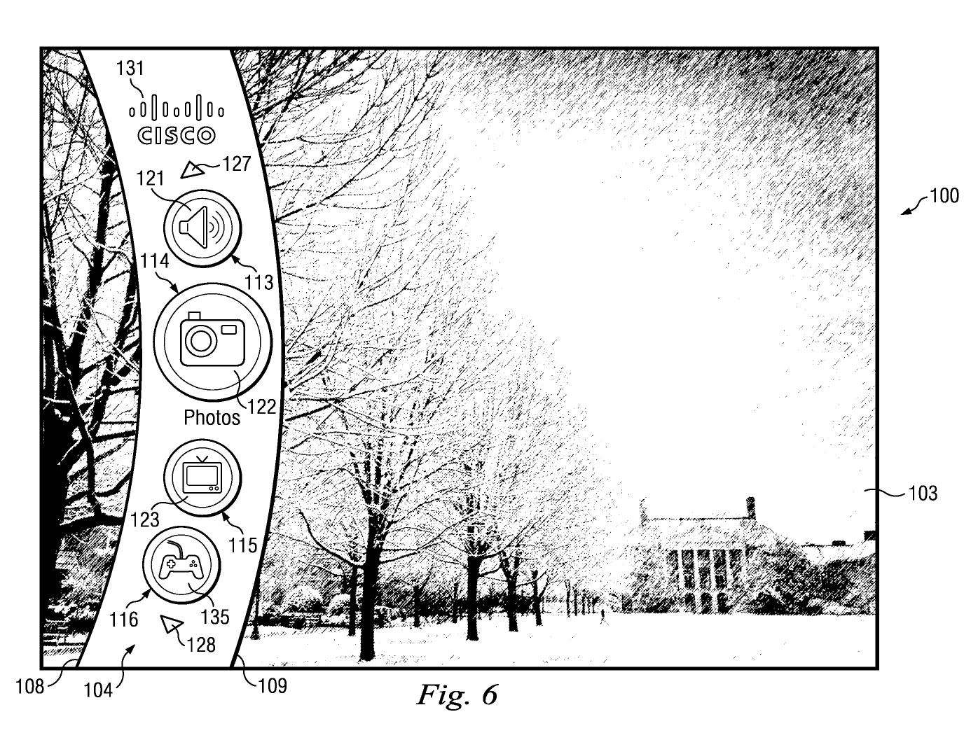

FIG. 6 is a diagrammatic representation of the user interface 104 that may be displayed along with multimedia content 103 on the TV display 38 shown in the LAN 12 of FIG. 1, and illustrating the user interface 104 in a different state than the states shown in FIGS. 4 and 5. Similar features in FIGS. 4-6 are numbered the same for the sake of clarity and simplicity. Moreover, the following discussion focuses primarily on the differences. In the state shown in FIG. 6, the icon 113 may include the image 121 that depicts “Music.” The icon 114 may include the image 122 that depicts “Photos.” Moreover, the navigational indicator 124 that is adjacent to the icon 114 may indicate that the category represented by the image 122 is “Photos.” Further, the icon 115 may include the image 123 that depicts “Video.” In addition, the icon 116 may include an image 135 that depicts “Games.” The images 121-123, 135 (“Music,” “Photos,” “Video,” and “Games”) are visual cues that are visible on the user interface 104 and therefore are visible visual cues.

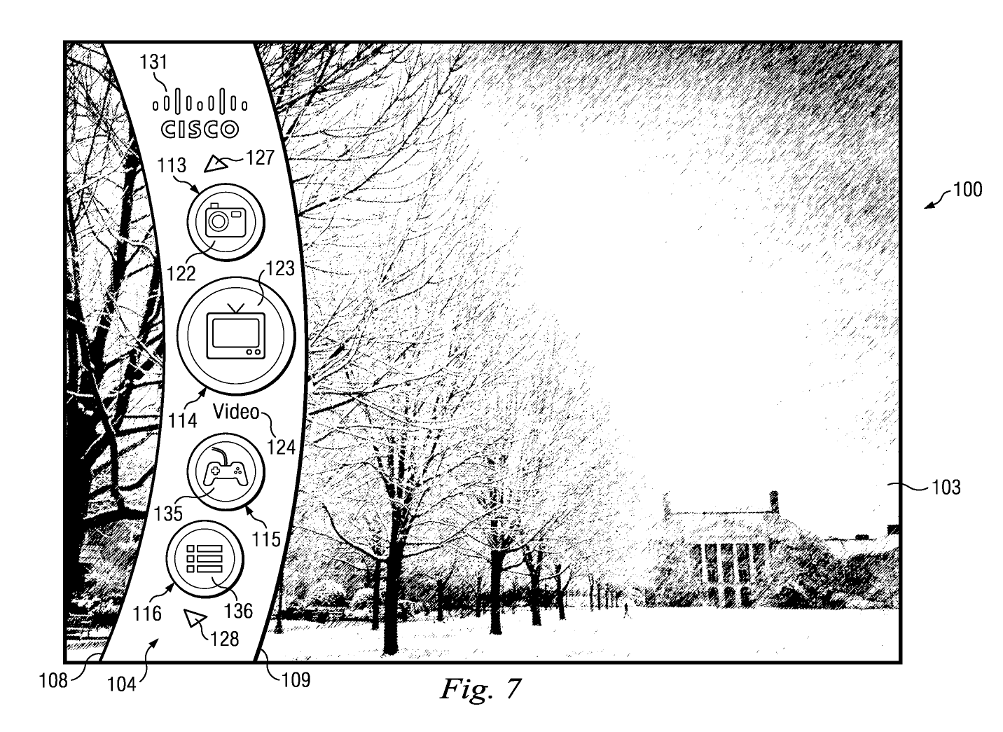

FIG. 7 is an example diagrammatic representation of the user interface 104 that may be displayed along with multimedia content 103 on the TV display 38 shown in the LAN 12 of FIG. 1, and illustrating the user interface 104 in a different state than the states shown in FIGS. 4-6. Similar features in FIGS. 4-7 are numbered the same for the sake of clarity and simplicity. Moreover, the following discussion focuses primarily on the differences. In the state shown in FIG. 7, the icon 113 may include the image 122 that depicts “Photos.” The icon 114 may include the image 114 that depicts “Video.” Moreover, the navigational indicator 124 that is adjacent to the icon 114 may indicate that the category represented by the image 122 is “Video.” Further, the icon 115 may include the image 135 that depicts “Games.” In addition, the icon 116 may include an image 136 that depicts “List View.” The images 122, 123, 135, 136 (“Photos,” “Video,” “Games,” and “List View”) are visual cues that are visible on the user interface 104 and therefore are visible visual cues.

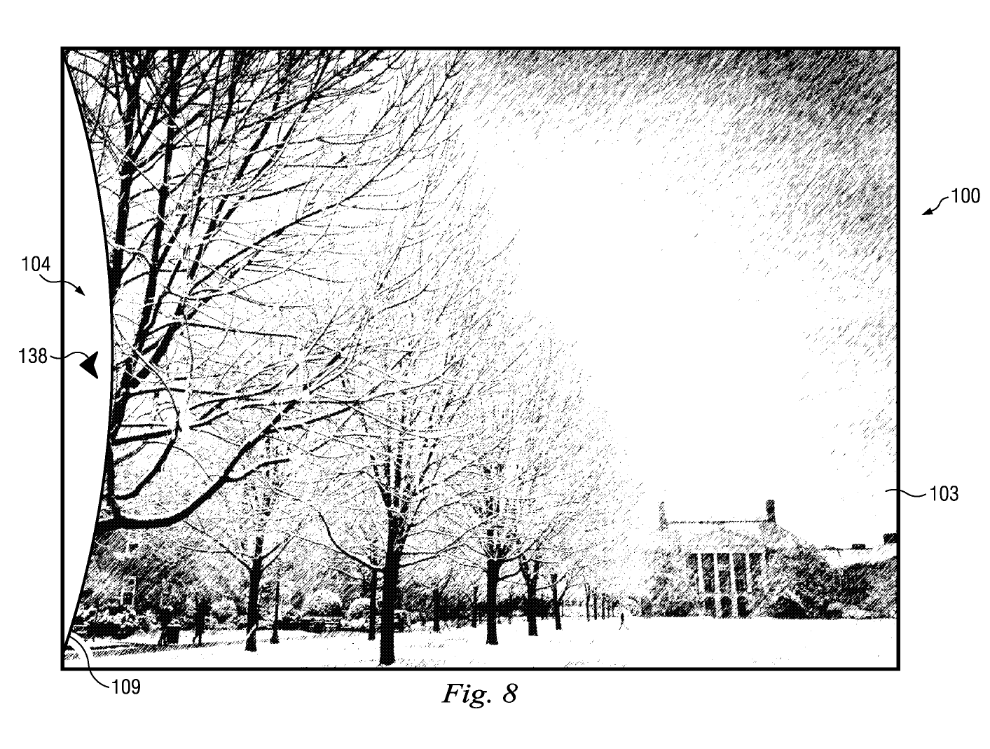

FIG. 8 is an example diagrammatic representation of the user interface 104 that may be partially displayed along with multimedia content 103 on the TV display 38 shown in the LAN 12 of FIG. 1, and illustrating the user interface 104 in a different state than the states shown in FIGS. 4-7. Similar features in FIGS. 4-7 are numbered the same for the sake of clarity and simplicity. Moreover, the following discussion focuses primarily on the differences. In the state shown in FIG. 8, a portion of the user interface 104 is shown. The portion of the interface 104 includes an arrow 138. The arrow 138 is a subtle graphic indicator that the user may navigate to the left to retrieve the entire user interface 104 as shown in FIGS. 4-7.

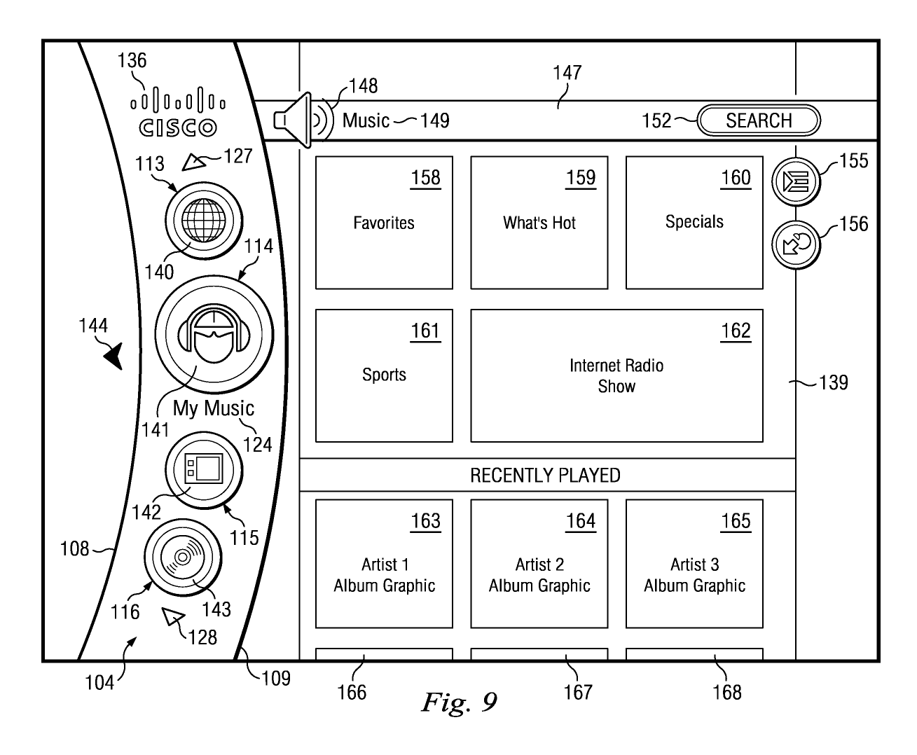

FIG. 9 is an example diagrammatic representation of the user interface 104 that may be displayed along with a plurality of music content 139 on the TV display 38 shown in the LAN 12 of FIG. 1, and illustrating the user interface 104 in a different state than the states shown in FIGS. 4-8. Similar features in FIGS. 4-8 are numbered the same for the sake of clarity and simplicity. Moreover, the following discussion focuses primarily on the differences. In the state shown in FIG. 9, the icon 113 may include an image 140 that depicts “Online Music.” The icon 114 may include an image 141 that depicts “My Music.” Moreover, the navigational indicator 124 that is adjacent to the icon 114 may indicate that the category represented by the image 141 is “My Music.” Further, the icon 115 may include an image 142 that depicts “Internet Audio.” In addition, the icon 116 may include an image 143 that depicts “CD/DVD.” The images 140-143 (“Online Music,” “My Music,” “Internet Audio,” and “CD/DVD”) are visual cues that are visible on the user interface 104 and therefore are visible visual cues.

In addition, in the state shown in FIG. 9 the TV display 38 may show an arrow 144. The arrow 144 is a subtle graphic indicator that the user may navigate to the left to return back to the initial categories. For example, by navigating left the user may return the user interface 104 into a state that is similar to the state shown in FIG. 4.

In the state shown in FIG. 9, the display 38 may include an overlay banner 147 to provide further navigational direction to the user. The overlay banner 147 may include a breadcrumb trail for information hierarchy. For example, the overlay banner 147 may include a navigational category icon 148 that depicts an image that is similar to the image 121 that depicts the category “Music.” The overlay banner 147 may further include a navigational category indicator 149 that shows “Music” and is adjacent to the navigational category icon 148. The overlay banner 147 may also include a search button 152. The search button 152 in the state shown in FIG. 9 may allow a user to initiate a contextual search of “Music” content.

In addition, the state of the TV display 38 under the present discussion may include a playlist accessory icon 155. The playlist accessory icon 155 may allow the user to create a custom music playlist. For example, the user may add all songs to the custom music playlist or select individual songs. The custom music playlist may be given a name, saved, and sent to a friend. Also, addition music may be added to the custom music playlist. Moreover, the TV display 38 under the present discussion may include an options accessory icon 156. The options accessory icon 156 may allow the user to set default music that automatically plays when accessing the “Music” navigational category. The plurality of music content 139 on the TV display 38 may include graphical depictions 158-168 of music content that is available to the user. For example, songs 163-165 may be represented graphically by corresponding albums covers for the respective musical Artists 1-3. Additional music content may be brought into the display 38 using the navigational buttons 94-97 on the remote control 42.

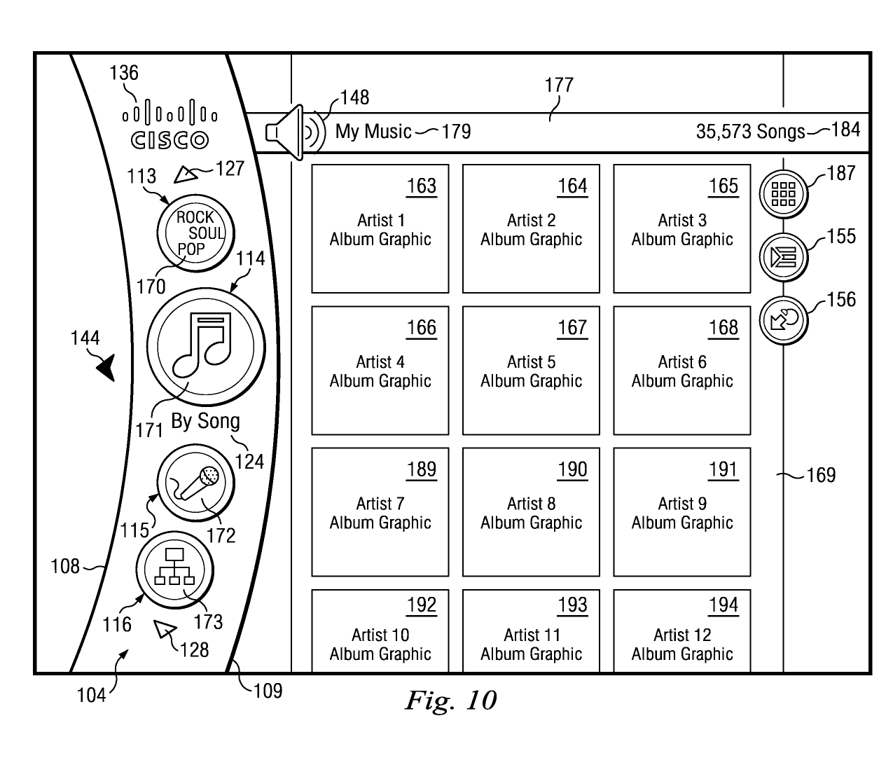

FIG. 10 is an example diagrammatic representation of the user interface 104 that may be displayed along with a plurality of music content 169 on the TV display 38 shown in the LAN 12 of FIG. 1, and illustrating the user interface 104 in a different state than the states shown in FIGS. 4-10. Similar features in FIGS. 4-9 are numbered the same for the sake of clarity and simplicity. Moreover, the following discussion focuses primarily on the differences. In the state shown in FIG. 10, the icon 113 may include an image 170 that depicts navigation “By Genre.” The icon 114 may include an image 171 that depicts navigation “By Song.” Moreover, the navigational indicator 124 that is adjacent to the icon 114 may indicate that the category represented by the image 171 is “My Music.” Further, the icon 115 may include an image 172 that depicts navigation “By Artist.” In addition, the icon 116 may include an image 173 that depicts navigation “By Source.” The images 170-173 (“By Genre,” “By Song,” “By Artist,” and “By Source”) are visual cues that are visible on the user interface 104 and therefore are visible visual cues.

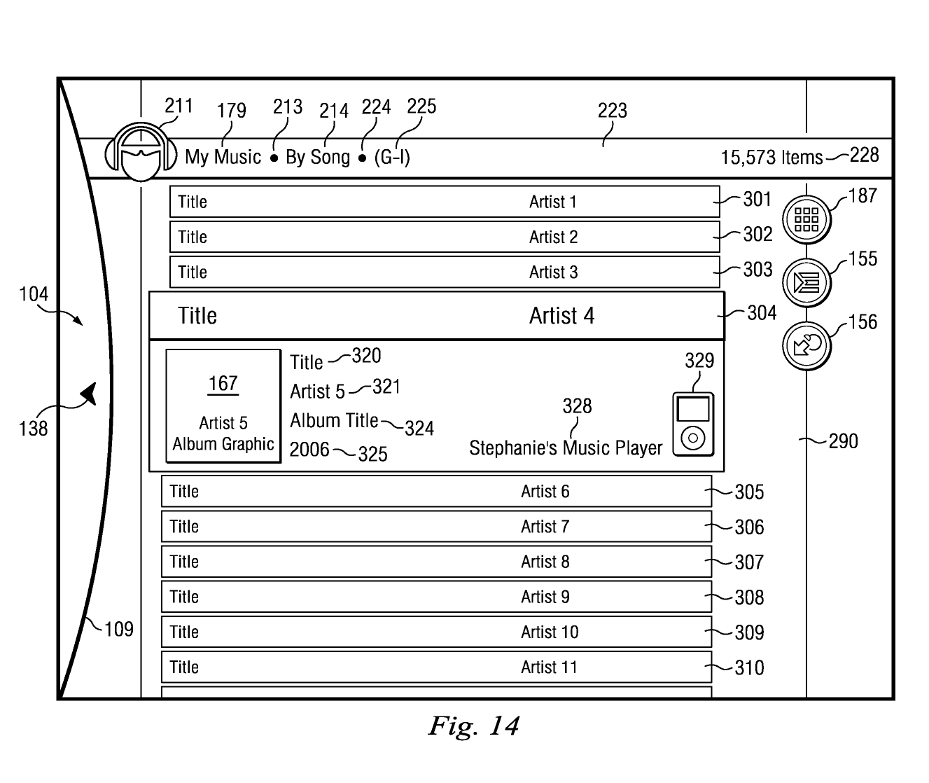

In the state shown in FIG. 10, the display 38 may include an overlay banner 177 to provide further navigational direction to the user. Similar features of the overlay banner 177 and the overlay banner 147 (FIG. 9) are numbered the same for the sake of clarity and simplicity. Moreover, the following discussion focuses primarily on the differences. The overlay banner 177 may include a breadcrumb trail for information hierarchy. For example, the overlay banner 177 may include the navigational category icon 148 that depicts an image that is similar to the image 121 that depicts the category “Music.” Moreover, the overlay banner 177 may include a navigational category indicator 179 that shows “My Music” and is adjacent to the navigational category icon 148. The overlay banner 177 may also include a song count indicator 184. The song count indicator 184 may display the number of songs that are accessible. In addition, the display 38 may show the playlist accessory icon 155 and the options accessory icon 156, as shown in FIG. 9. Further, the display 38 may show a graphic/list view accessory icon 187. The graphic/list view accessory icon may allow the user to toggle between a graphic display of content (as shown in FIG. 10) and a text display of content, which can provide additional information as seen in more detail later. When the display 38 shows content in graphical view, the graphic/list view accessory icon 187 may include an image that illustrates text view (as shown in FIG. 10). When the display 38 shows content in text view, the graphic/list view accessory icon 187 may include an image that illustrates graphic view (as shown later in FIG. 14). Also, the display 38 may show a portion of the songs that is accessible to a user. In particular, the illustration shown in FIG. 10 may show songs 163-168 and songs 189-194. For example, the songs 163-168 and 189-194 may be represented graphically by corresponding albums covers for the respective musical Artists 1-12.

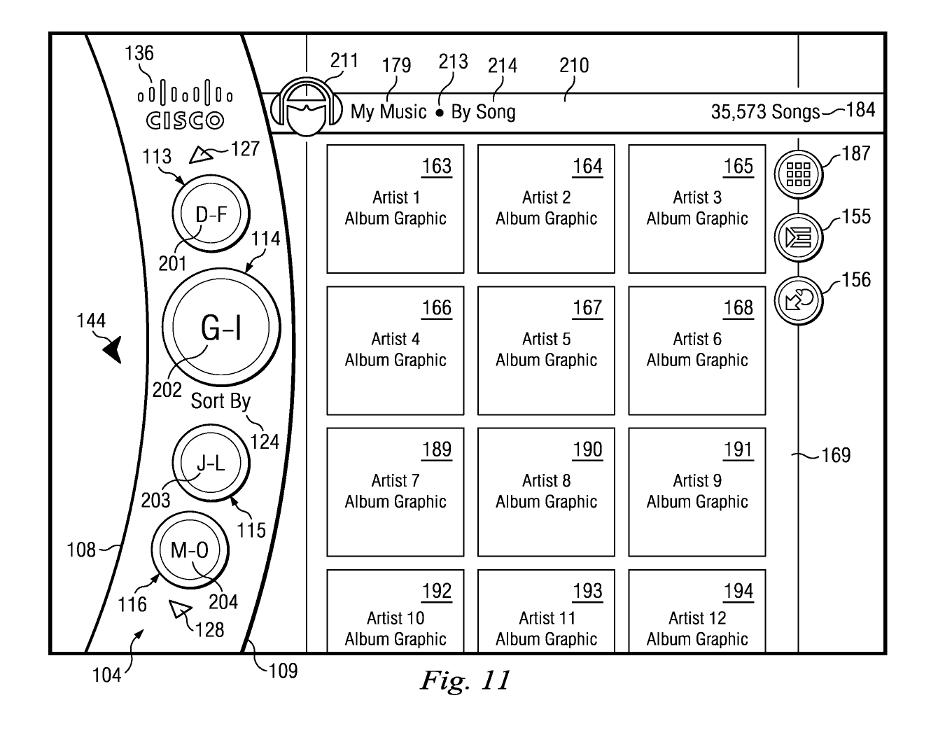

FIG. 11 is an example diagrammatic representation of the user interface 104 that may be displayed along with a plurality of music content 169 on the TV display 38 shown in the LAN 12 of FIG. 1, and illustrating the user interface 104 in a different state than the states shown in FIGS. 4-10. Similar features in FIGS. 4-10 are numbered the same for the sake of clarity and simplicity. Moreover, the following discussion focuses primarily on the differences. In the state shown in FIG. 11, the icon 113 may include an image 201 that depicts navigation by song titles beginning with alphabetical letters “D-F.” The icon 114 may include an image 202 that depicts navigation by song titles beginning with alphabetical letters “G-I.” Moreover, the navigational indicator 124 that is adjacent to the icon 114 may indicate that the category represented by the image 124 is “Sort By.” Further, the icon 115 may include an image 203 that depicts navigation by songs titles beginning with alphabetical letters “J-L.” In addition, the icon 116 may include an image 204 that depicts navigation by song titles beginning with alphabetical letters “M-O.” The images 201-204 (“D-F,” “G-I,” “J-L,” and “M-O”) are visual cues that are visible on the user interface 104 and therefore are visible visual cues.

In the state shown in FIG. 11, the display 38 may include an overlay banner 210 to provide further navigational direction to the user. Similar features of the overlay banner 210 and the overlay banner 177 (FIG. 10) are numbered the same for the sake of clarity and simplicity. Moreover, the following discussion focuses primarily on the differences. The overlay banner 210 may include a breadcrumb trail for information hierarchy. For example, the overlay banner 210 may include the sub-navigational category icon 211 that depicts an image that is similar to the image 141 (FIG. 9) that depicts the category “My Music.” Moreover, the overlay banner 210 may include a sub-navigational category indicator 179 that shows “My Music” and may be adjacent to the sub-navigational category icon 211. A spacer icon 213 may be adjacent to the sub-navigational category icon 211. Another sub-navigational category indicator 214 may be adjacent to the spacer 213. The sub-navigational category index 214 may show “By Song.” Also, the display 38 may show a portion of the songs that is accessible to a user. For example, the illustration shown in FIG. 11 shows songs 189-194 and songs 163-168. The songs 163-168 and 189-194 may be represented graphically by corresponding albums covers for the respective musical Artists 1-12.

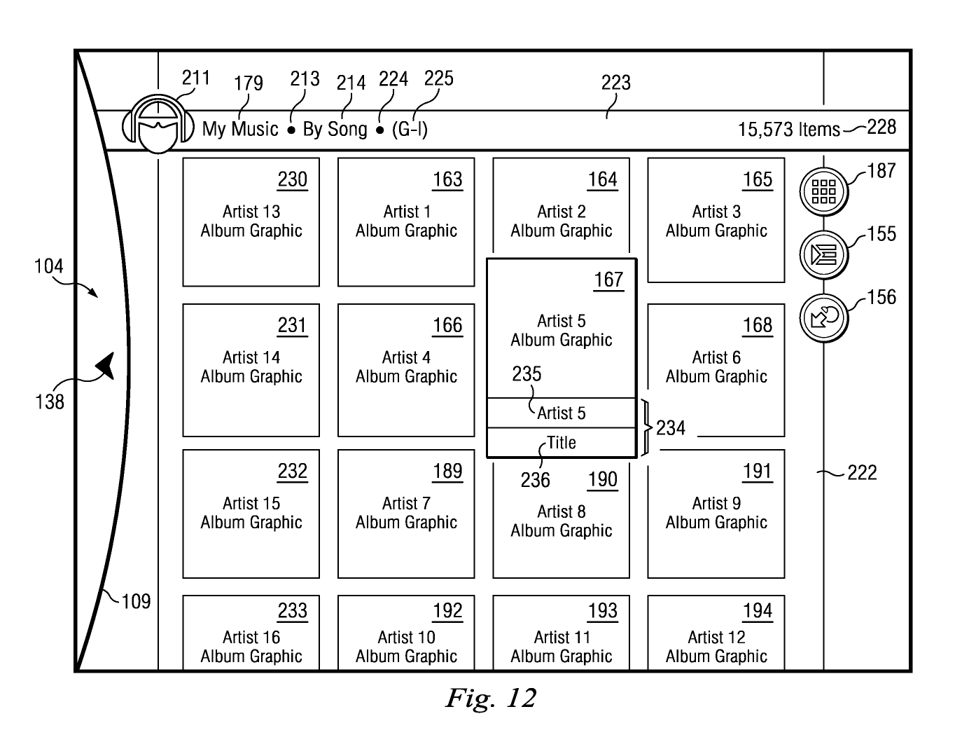

FIG. 12 is an example diagrammatic representation of the user interface 104 that may be partially displayed along with a plurality of music content 222 on the TV display 38 shown in the LAN 12 of FIG. 1, and illustrating the user interface 104 in a different state than the states shown in FIGS. 9-11. Similar features in FIGS. 9-11 are numbered the same for the sake of clarity and simplicity. Moreover, the following discussion focuses primarily on the differences. In the state shown in FIG. 12, the user interface 104 may be partially displayed in the same manner as shown in FIG. 8.

In the state shown in FIG. 12, the display 38 may include an overlay banner 223 to provide further navigational direction to the user. Similar features of the overlay banner 223 and the overlay banner 210 (FIG. 11) are numbered the same for the sake of clarity and simplicity. Moreover, the following discussion focuses primarily on the differences. The overlay banner 223 may include a breadcrumb trail for information hierarchy. For example, the overlay banner 223 may include a spacer icon 224 that may be adjacent to the sub-navigational category indicator 214 that displays “By Song.” Moreover, the overlay banner 223 may include another sub-navigational category indicator 225 that may be adjacent to the spacer 224. The sub-navigational category indicator 225 may show “(G-I).” In addition, the overlay banner 223 may include an item count indicator 228 that may display the number of song titles beginning with the alphabetical letters G-I.

Further, in the state shown in FIG. 12, the display 38 may show a portion of the songs that are accessible to a user. For example, the illustration shown in FIG. 12 shows songs 163-168, 189-194, and 230-233. The songs 163-168 and 189-194 may be represented graphically by corresponding albums covers for the respective musical Artists 1-12. Moreover, the songs 230-233 may be represented graphically by corresponding albums covers for the respective musical Artists 13-16. In addition, a text view block 234 may appear below the song graphic 167. The text view block 234 may include an artist's name 235 corresponding to the song graphic 167. Moreover, the text view block 234 may include a song title 236 that corresponds to the song graphic 167.

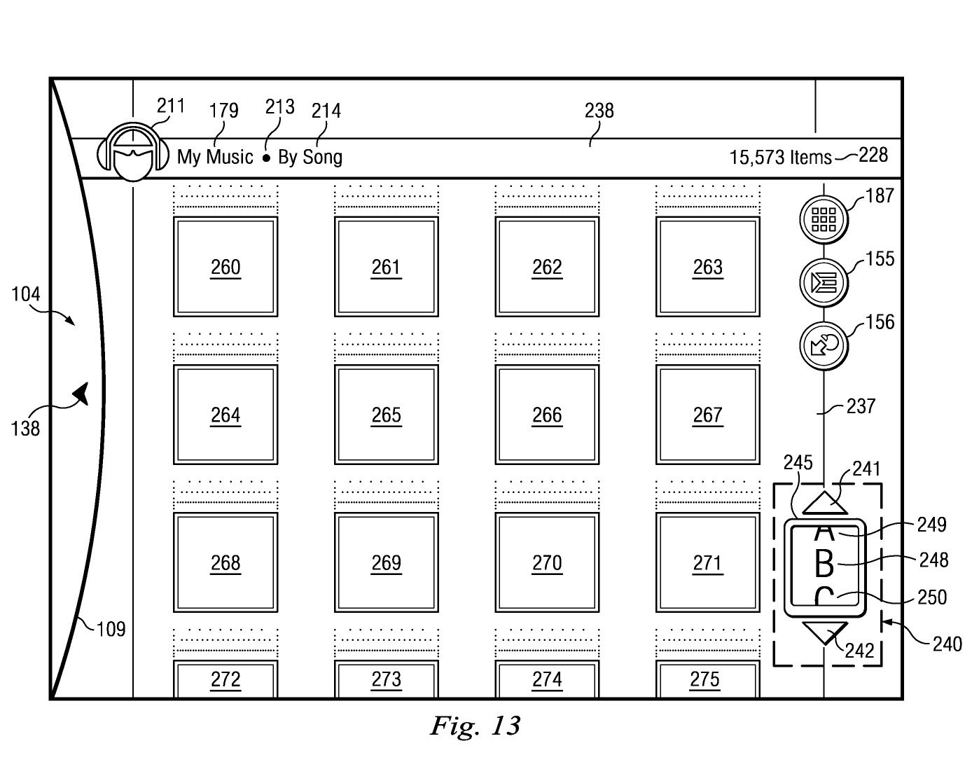

FIG. 13 is an example diagrammatic representation of the user interface 104 that may be partially displayed along with a plurality of music content 222 on the TV display 38 shown in the LAN 12 of FIG. 1, and illustrating the user interface 104 in a different state than the states shown in FIGS. 9-12. Similar features in FIGS. 9-12 are numbered the same for the sake of clarity and simplicity. Moreover, the following discussion focuses primarily on the differences. In the state shown in FIG. 13, the user interface 104 may be partially displayed in the same manner as shown in FIG. 8.

Moreover, in the state shown in FIG. 13, the display 38 may include an overlay banner 238 to provide further navigational direction to the user. Similar features of the overlay banner 238 and the overlay banner 223 (FIG. 12) are numbered the same for the sake of clarity and simplicity. Moreover, the following discussion focuses primarily on the differences. The overlay banner 238 may be identical to the overlay banner 223 (FIG. 12) except that the spacer 224 and the sub-navigational category indicator “G-I” may not be displayed.

In addition, the display 38 may show a scroll wheel 240 that is a scrolling feature. The scroll wheel 240 may include and upper arrow 241 and a lower arrow 242. The arrows 241, 242 may indicate that the user can scroll respectively forward and backward on the scroll wheel using the corresponding scroll wheel 99 on the remote control 42 (FIG. 3). The scroll wheel 240 may include a navigational indicator 245. The navigational indicator 245 may display the current alphabetical letter that is currently being viewed. For example, in the state shown in FIG. 13, the navigational indicator 245 may include an alphabetical character 248 that displays the letter “B.” Moreover, the navigational indicator 245 may include alphabetical characters 249, 250 that are respectively above and below the alphabetical character 248 (“B”). The alphabetical character 249 may display a bottom portion of the alphabetical letter “A” and the alphabetical character 250 may display the top portion of the alphabetical letter “C.” Therefore, the state shown in FIG. 13 corresponds to a snapshot in time when the user may presently be at the letter “B” while scrolling through the scroll wheel 240 using the scroll wheel 99 on the remote control 42 (FIG. 3).

Further, in the state shown in FIG. 13, the display 38 may show a snapshot of songs titles that begin with the alphabetical letter “B” while the user is scrolling through the scroll wheel 240 displayed on the display 38 while using the scroll wheel 99 on the remote control 42 (FIG. 3). For example, the illustration shown in FIG. 13 shows songs 260-275. The graphical view of each song title may not be visible because the illustration in FIG. 13 is a snapshot in time of the display 38 while the user may be scrolling through the scroll wheel 240 using the scroll wheel 99 on the remote control 42 (FIG. 3).

FIG. 14 is an example diagrammatic representation of the user interface 104 that may be partially displayed along with a plurality of music content 290 on the TV display 38 shown in the LAN 12 of FIG. 1, and illustrating the user interface 104 in a different state than the states shown in FIGS. 9-13. Similar features in FIGS. 9-13 are numbered the same for the sake of clarity and simplicity. Moreover, the following discussion focuses primarily on the differences. In the state shown in FIG. 14, the user interface 104 may be partially displayed in the same manner as shown in FIG. 8. In addition, the display 38 may show an overlay banner 223 as shown in FIG. 12. The display 38 may further show a plurality of music content 290 in textual view. Therefore, the accessory icon 187 may now display an image that shows graphic view. The user may toggle back to graphic view of the plurality of music content 290 by selecting the graphic/text view accessory icon 187. The plurality of music content 290 may include a list of song titles and corresponding artists. Each combination of song title and corresponding artist may be shown in items 301-310, and correspond respectively to the songs 163-168 and 189-193.

In addition, the item 304 may appear different than the rest of the items 301-303 and 305-310. The item 304 may correspond to the song 167 (FIGS. 10-12). The item 304 may be selected by a user and may include additional information about the item 304. For example, the graphical representation 167 of the item 304 may be displayed. The title 320 and the artist 321 corresponding to the title and artist shown in item 304 may be displayed adjacent to the graphical representation 167 of the item 304. Moreover, an album name 324 and an album year 236 corresponds to the item 304 and may also be displayed adjacent to the graphical representation 167. The display 38 further may show the source of the item 304. For example, the source indicator 328 may show that the item 304 is located in “Stephanie's Music Player.” Moreover, the graphic indicator 329 may show an image of a digital music player to graphically indicate the source of the item 304.

Now a description of the operation of the DMA 33 (FIG. 1) and the user interface 104 is provided while referring to FIGS. 1-13. The DMA 33 may access content from components in the system 10, such as the router 21, the USB storage device 22, the computer 28, the NAS device 28, the IP network camera 32, and the video camera 36. In addition, the DMA 33 may access remote content from the internet 17. The DMA 33 may decode content from these components and may display the content on the TV display 38.

A user may access digital media content in the LAN 12 by using the user interface 104. The DMA 33 may include software that operates the user interface 104 that may be displayed on the TV display 38. The user may navigate the user interface 104 that displays on the TV display 38 using the remote control 42 that communicates wirelessly with the DMA 33 over the RF communication link 41. Alternatively, the TV display 38 may include a display that the user touches to navigate using the user interface 104. Also, alternatively the DMA 33 may provide voice activation capability so that a user can navigate content shown on the TV display 38 using their voice.

Referring to FIG. 1, in operation a user in the residential environment may access content using the DMA 33. For example, a user may access content from the internet content service provider 15 and the internet 17. In addition, a user may access content from locations within the LAN 12. In particular, a user may access content from the computer 27, the NAS 28, the IP network camera 32, and the video camera. The user may navigate content using the interface 104 provided by the DMA 33.

Referring to FIG. 2, in operation the flash 62 in the DMA 33 may store software that when executed operates the user interface 104. The DMA 33 may interact with the various components in the WAN 11 and LAN 12. The DMA 33 may display the user interface 104 (FIG. 4) on the TV display 38 so that the user can navigate the content made available by the various components in the WAN 11 and LAN 12. For example, the user may use the remote control 42 to interact with the user interface 104 that is displayed on the TV display 38. Alternatively, the TV display 30 may includes a display that the user can touches to interact with the user interface 104.

Now a general description of the operation of the user interface 104 is described. The user interface 104 (FIG. 4) may appear to a user as a portion of a vertical carousel. The user interface 104 may be presented on the TV display 38 until the user enters the content space by selecting the right arrow 97 on the remote control 42. (FIG. 3). At that point, the user interface 104 transitions off the TV display 30 to the left and may be accessible again, for example, when the user navigates to the left or selects the menu button 93 on the remote control 42 (FIG. 3).

The icon 114 on the user interface 104 focuses on a navigational category. This may be accomplished by a “lensing” or “illumination” effect. The user interface 104 can put the focus in one spot (icon 114) while navigational categories move into and out of the icon 114 via the carousel. The user may selects the arrows 94-97 on the remote control 42 (FIG. 3) to move the navigational categories into and out of the icon 114. In this manner, the user interface 104 may appear to a user as a portion of a vertical carousel that moves continuously as the user navigates. For example, as the user selects the up arrow 94 the carousel appears to move upward and as the user selects the down arrow 95 the carousel appears to move downward. Alternatively, the user interface 104 may appear as a carousel that moves upward as the user selects the down arrow 95 and that moves downward as the user selects the up arrow 94.

Now examples are presented to further explain the operation of the user interface 104. Referring FIG. 4, the state of the user interface 104 may show a subsection of global navigational categories. For example, the state of the user interface 104 may show global navigational categories “Sources” (image 120 in icon 113), “Music” (image 121 at icon 114), “Photos” (image 122 at icon 115), and Video (image 123 at icon 116). The global navigational category “Music” may be illuminated as shown in FIG. 3. The user may select the category “Music” by pressing the select button 98 on the remote control 42 (FIG. 3). Also, the user may navigate through the global navigational categories using the arrows 127 and 128. For example, the user may select the down arrow 128 once to move the global navigational category “Sources” (image 120) into the illuminated icon 114. The user may select the down arrow 128 on the user interface 104 by pressing the down arrow 95 of the remote control 42.

FIG. 5 shows the state of the user interface 104 after a user selects the down arrow 128 once from the state of the user interface 104 shown in FIG. 4. This selection by the user may advance the global navigational categories down the user interface 104 by two icons. For example, the image 120 (“sources”) may move from the icon 113 (FIG. 4) into the icon 114. In other words, the global navigational category “Sources” may now appear in the icon 114 and is illuminated. In that regard, the user can now select the category “Sources” by pressing the select button 98 on the remote control 42 (FIG. 3). In addition, the global navigational categories “Music” and “Photos” have shifted down the user interface 104. For example, the global navigational category “Music” has moved from the icon 114 (FIG. 4) into the icon 115. The global navigational category “Photos” has moved from the icon 115 (FIG. 4) into the icon 116. In addition, the global navigational category “Video” is no longer visible on the user interface 104. For example, the category “Video” moved has moved the icon 116 off the user interface 104. In addition, another global navigational category “Settings” depicted by the image 134 is shown in the icon 113. The new image 134 (“Settings”) not previously shown in FIG. 4 moved into the icon 113 to replace the “Sources” image 120 that moved from the icon 113 into the icon 114. The user may further navigate to the global navigational category “Photos” by selecting the up arrow 127 twice. For example, the user may select the up arrow 94 on the remote control 42 (FIG. 3) twice to advance the global navigational category “Photos” from the icon 116 into the icon 114 so that it can be selected by the user. The user interface 104 further includes a branding area 131.

FIG. 6 shows the state of the user interface 104 after a user selects the up arrow 127 twice from the state of the user interface 104 shown in FIG. 5. This selection by the user may advance the global navigational categories up the user interface 104 by two icons. For example, the image 122 (“Photos”) may move from the icon 116 (FIG. 5) into the icon 114 (FIG. 6). In other words, the global navigational category “Photos” may now appear in the icon 114 and is illuminated. In that regard, the user may now select the category “Photos” by pressing the select button 98 on the remote control 42 (FIG. 3). In addition, the global navigational categories “Music” and “Video” have shifted up the user interface 104. For example, the global navigational category “Music” has moved up two icons from the icon 115 (FIG. 5) into the icon 113. The global navigational category “Video” (shown as image 123 in FIG. 4) has moved into the icon 115. In addition, the global navigational categories “Settings” and “Sources” (images 134 and 120 respectively shown in FIG. 5) are no longer visible on the user interface 104. For example, the category “Settings” (image 134 shown in FIG. 5) has moved from the icon 113 off the user interface 104. Moreover, the category “Sources” (image 120 shown in FIG. 5) has moved the icon 114 off the user interface 104. In addition, another global navigational category “Games” depicted by the image 135 is shown in the icon 116. The new image 135 (“Games”) not previously shown in FIGS. 4 and 5 has moved into the icon 116 to replace the “Photos” image 122 that moved from the icon 116 into the icon 114. The user may further navigate to the global navigational category “Video” by selecting the down arrow 128 once. For example, the user selects the up arrow 95 on the remote control 42 (FIG. 3) once to advance the global navigational category “Video” from the icon 115 into the icon 114 so that it can be selected by the user.

FIG. 7 shows the state of the user interface 104 after a user selects the up arrow 127 once from the state of the user interface 104 shown in FIG. 6. This selection by the user may advance the global navigational categories up the user interface 104 by one icon. For example, the image 122 (“Photos”) may move from the icon 114 (FIG. 6) into the icon 114 (FIG. 7). The image 123 (“Video”) may move from the icon 115 (FIG. 6) into the icon 114 (FIG. 7). In other words, the global navigational category “Video” may now appear in the icon 114 and is illuminated. In that regard, the user may now select the category “Video” by pressing the select button 98 on the remote control 42 (FIG. 3). In addition, the global navigational categories “Games” (depicted as image 135) has shifted from the icon 115 (FIG. 6) into the icon 115 (FIG. 7). In addition, the global navigational category “Music” (depicted as image 121) has shifted from the icon 113 (FIG. 6) and is no longer visible on the user interface 104. In addition, another global navigational category “Network Guide” depicted by the image 136 is shown in the icon 116. The new image 136 (“Network Guide”) not previously shown in FIGS. 4-6 has moved into the icon 116 to replace the “Games” image 135 that moved from the icon 116 into the icon 115. The “Network Guide” may allow a user to quickly see all of their favorite channels.

The user interface 104 may also allow a user to increase visibility of content on the TV display 38 by temporarily hiding the user interface 104. For example, when a user navigates into the content space the user interface 104 transitions off the display 38. For example, one way a user can transition the user interface 104 off the TV display 38 may be to select the right arrow 97 on the remote control 42 (FIG. 3).

FIG. 8 shows the state of the user interface 104 after the user has navigated into the content space on the display 38. For example, only a portion of the user interface 104 may be present. In particular, the left edge 108 of the user interface 104 may no longer visible on the TV display 38. The right edge 109 may remain visible on the TV display 38 but has shifted left. Moreover, the portion of the user interface 104 visible on the TV display 38 may include an arrow 138. The arrow 138 may provide the ability for the user to retrieve the entire user interface 104. For example, the user may retrieve the entire user interface 104 by selecting the arrow 138. In that regard, the user may press the left arrow 96 on the remote control 42 (FIG. 3) to retrieve the entire user interface 104 so that it is again displayed on the TV display 38 as shown in FIGS. 4-7.

Now a description of the operation of the user interface 104 is explained with respect to navigation of sub-categories. For sake of clarity and simplicity, not all sub-navigational categories will be explained in further detail. For purposes of highlighting scaling and dynamic navigational capabilities of the user interface 104, the description that follows focuses on the navigational category “Music” represented by the image 121 in icon 114 (FIG. 4). Referring back to FIG. 4, the global navigational category “Music” (image 121) may be shown in the icon 114 that is illuminated and selectable by the user. The user may navigate to the “Music” category by selecting the icon 114 using the select button 98 on the remote control 42 (FIG. 3).

FIG. 9 shows the state of the user interface 104 and the TV display 38 after the user selects the global navigational category “Music.” As shown in FIG. 9, the icons 113-116 of the user interface 104 may now include new images 140-143 that represent some of the sub-categories of the global navigational category “Music.” For example, the icon 113 may include the image 140 that represents the sub-category “Online Music.” The icon 114 may include the image 141 that represents the sub-category “My Music.” In addition, the navigational indicator 124 may show the word “My Music.” Moreover, the icon 115 may include the image 142 that represents the sub-category “Internet Radio.” The icon 116 may include the image 143 that represents the sub-category “CD/DVD.” In all other respects, the user interface 104 shown in FIG. 9 may appear the same as the user interface 104 shown in FIG. 4. Moreover, the sub-categories “Online Music,” “Internet Radio,” and “CD/DVD” depicted by the images 140, 142, 143 may be navigated into and out of the selectable icon 114 in the same manner the user navigates through the global navigational categories.

FIG. 10 shows the state of the user interface 104 and the TV display 38 after the user selects the sub-category “My Music” (FIG. 9). As shown in FIG. 10, the icons 113-116 of the user interface 104 may now respectively include new images 170-173 that represent some of the further sub-categories of the sub-category “My Music.” For example, the icon 113 may include the image 170 that represents the sub-category “By Genre.” The icon 114 may include the image 171 that represents the sub-category “By Song.” In addition, the navigational indicator 124 may show the word “By Song.” Moreover, the icon 115 may include the image 172 that represents the sub-category “By Artist.” The icon 116 may include the image 173 that represents the sub-category “By Source.” In all other respects, the user interface 104 shown in FIG. 10 may appear the same as the user interface 104 shown in FIG. 9. Moreover, the sub-categories “By Genre,” “By Artist,” and “By Source” depicted by the images 170, 172, 173 may be navigated into and out of the selectable icon 114 in the same manner the user navigates through the global navigational categories.

The user may further navigate “By Song” by selecting the icon 114 using the select button 98 on the remote control 42 (FIG. 3). FIG. 11 shows the state of the user interface 104 and the TV display 38 after the user selects the sub-category “By Song” (FIG. 10). As shown in FIG. 11, the icons 113-116 of the user interface 104 may now respectively include new images 201-204 that represent some of the further sub-categories of the sub-category “By Song.” For example, the icon 113 may include the image 201 that depicts navigation by song titles beginning with alphabetical letters “D-F.” The icon 114 may include the image 202 that depicts navigation by song titles beginning with alphabetical letters “G-I.” In addition, the navigational indicator 124 may show the word “Sort By” to indicate that the icon 114 can be selected to sort songs by alphabetical letters “G-I.” Moreover, the icon 115 may include the image 203 that depicts navigation by song titles beginning with alphabetical letters “J-L.” The icon 116 may include the image 204 that depicts navigation by song titles beginning with alphabetical letters “M-O.” In all other respects, the user interface 104 shown in FIG. 11 may appear the same as the user interface 104 shown in FIG. 10. Moreover, the sub-categories “D-F,” “G-I,” and “M-O” depicted by the images 201, 203, 204 may be navigated into and out of the selectable icon 114 in the same manner the user navigates through the global navigational categories. Further, additional sub-categories such as “A-C” and “P-R” may not be visible in the state of the user interface 104 shown in FIG. 11. However, the user may navigate to these additional sub-categories in the same manner as described above with respect to the global navigational categories.

FIG. 12 shows the state of the user interface 104 and the TV display 38 after the user has navigated onto the content shown in FIG. 11. Recall that the user may navigate onto the content shown in FIG. 11 by selecting the right arrow 97 on the remote control 42 (FIG. 3). In doing so, much of the user interface 104 may be removed from the display 38 while a portion may remain on the display as shown in FIG. 12. When the majority of the user interface 104 transitions off the TV display 38 additional music may be shown on the TV display 38. For example, the display 38 may show a plurality of music 222 that includes the plurality of music 169 (FIG. 11) along with additional music 230-233. The user may select through the plurality of music content 222 by using the navigational arrows 94-97 on the remote control 42 (FIG. 3). As the user selects each of the songs in the plurality of music content 222 the respective song may be highlighted. For example, in FIG. 12 the user may navigate to the song 167. The graphical view of the song 167 may be enlarged relative to the songs. In addition, an image 234 may appear below the enlarged graphical view of the song 167 to provide further information to the user. In the example under present discussion, the image 234 may include the artist name 235 and the song title 236. If the user selects a play button or the select button 98 on the remote control 42 (FIG. 3), the song title 236 may play.

While browsing the visual environment on the TV display 38, a user may dramatically increase the speed of their browsing by using the scroll wheel 99 on the remote control 42 (FIG. 3). This navigation feature may be activated by pressing the scroll wheel 99 and deactivated by again pressing the scroll wheel 99. Alternatively, the scroll wheel may be deactivated when the user selects the arrow 138 to retrieve the entire user interface 104 back onto the TV display 38. For sake of the discussion that follows, assume the user presses the scroll wheel 99 while in the state shown in FIG. 11.

FIG. 13 shows the state of the user interface 104 and the content on the TV display 38 after a user has activated the scrolling navigation feature. In that regard, as soon as the scroll wheel 99 is pressed by the user the scroll wheel 240 may appear on the TV display 38 to let the user know where they are in the alphabetical order on the display 38. In addition, the user can highlight the scroll wheel 240 and may navigate to an alternative letter. By then pressing the select button 98 at the alternative alphabetical letter, the content corresponding to the alternative alphabetical letter may replace the alphabetical letter that appears on the display 38. In the state shown in FIG. 13, the user is scrolling through the alphabet while navigating the sub-category “My Music” for song titles. For example, in the state shown in FIG. 13, the user is currently on the alphabetical letter “B” as indicated by the alphabetical character 248 shown by the navigational indicator 245. The plurality of music content 237 includes songs 260-275. The graphical views corresponding to the songs 260-275 may not be clearly visible in FIG. 13 because the user is scrolling through the alphabet.

The navigational indicator 245 may appear three-dimensional and may be dynamic. The navigational indicator 245 may animate each alphabetical letter as it passes by while the user scrolls the scroll wheel 99 on the remote control 42 (FIG. 3). Moreover, the navigational indicator 245 may allow the user to slightly see the alphabetical letter before and after the current alphabetical letter 248. For example, shown directly above the alphabetical character “B” on the scroll wheel 240 is the bottom portion of the letter “A” (alphabetical character 249). Moreover, shown directly below the alphabetical character “B” on the scroll wheel 240 is the top portion of the letter “C” (alphabetical character 250). The three dimensional navigational indicator 245 may indicate to the user that once you may navigate down to the alphabetical letter “Z” that you may end up back at the alphabetical letter “A.” The arrow 241 may indicate to the user that scrolling the scroll wheel 99 upward on the remote control 42 (FIG. 3) may advance navigation to the alphabetical letter “A.” Moreover, the arrow 242 may indicate to the user that scrolling the scroll wheel 99 downward on the remote control 42 (FIG. 3) may advance navigation to the alphabetical letter “B.” Alternatively, the user may select the up arrow 94 on the remote control 42 (FIG. 3) to advance navigation of song titles from the alphabetical letter “B” to the alphabetical letter “A.” Also, alternatively the user may select the down arrow 95 on the remote control 42 (FIG. 3) to advance navigation of song titles from the alphabetical letter “B” to the alphabetical letter “C.”

While browsing the visual environment on the TV display 38, a user may toggle between a graphic display of content (as shown in FIG. 12) and a textual display of content as shown in FIG. 13. Textual display of content may provide the ability to learn more information about the respective content. For sake of the discussion that follows, assume the user is navigating by graphic display of content in the state shown in FIG. 12. The user may select the graphic/list view accessory icon 187 to toggle into textual display. The user may select the graphic/list view accessory icon 187 using the arrows 94-97 and the select button 98. Upon selection of the graphic/list view accessory icon 187, the state of the TV display 38 may change to the state shown in FIG. 14.

Referring back again to FIG. 14, the state of the TV display 38 shows the same substance as shown in its corresponding graphic view state. However, there are some differences. For example, the image of the graphic/list view accessory icon 187 changes from a list view image (shown in FIG. 12) to a list view image (shown in FIG. 14). Therefore, the TV display 38 now shows song titles and corresponding artist names (301-310) in textual view. The song titles and corresponding artist names (301-310) correspond to a portion of the graphic images 189-194, 163-168, and 230-233 that are shown in the graphic view (FIG. 12). For example, the graphic image 167 selected and highlighted in the graphic view (FIG. 12) is shown at 304 in the textual view (FIG. 14). Item 304 may include the song title 236 and the artist name 235 as shown in the corresponding graphic view (FIG. 12). The textual view shown in FIG. 14 provides further information about the item 304. For example, item 304 may include an album name 324 and album year 325 that corresponds to the song title 236. Moreover, the item 304 may include a textual view of a source 328 and a graphic view of the source 329 where the item 304 may be accessed. Further, the graphic/list view accessory icon 187 may now include a graphic view image. The user may toggle back to a graphical view (FIG. 12) of the state of the TV display 38 shown in FIG. 14 by selecting the graphic/list view accessory icon 187.

The user interface 104 may provide dynamic scaling. In particular, the user interface 104 may include intelligence so that narrowing of content may be categorized depending on how much content is available. For example, in the state of the TV display 38 shown in FIG. 11 the song count indicator 184 may display that there are 35,573 songs. To make navigation of so many songs manageable for the user, the user interface 104 may include alphabetical sub-categories limited to song titles starting with three different alphabetical letters (for example “D-F,” “G-I,” “J-L,” “M-O”). Therefore, when the user selects an alphabetical sub-category, the content that is navigable by the user may be a fraction of the total number of songs available and thus easier to navigate.

In contrast, now assume for sake of discussion that the song count indicator displays that there are only 100 song titles accessible to the user. Navigating 100 song titles is easier than navigating 35,753 song titles. Accordingly, the user interface 104 may narrow the content into two groups of song titles and includes two alphabetical sub-categories “A-M” and “N-Z” on the display for accessing the song titles. Alternatively, the user interface 104 may distribute the 100 song titles content in a lesser or greater number of alphabetical sub-categories as desired by the user. For example, the user may set preferences in the settings options.

In addition, the user interface 104 may provide dynamic navigation. The user may set preferences for dynamic navigation in the settings options. When the dynamic navigation feature is turned on, the global navigation and sub-navigation categories may appear on the user interface 104 based on the frequency the categories are selected by users. In other words, if the user most frequently navigates to the global navigational category “Music,” then the image 121 depicting the category “Music” would appear in the icon 114 so that it may be selected by the user without having to navigate through the categories. Moreover, if the user searches “My Music” by genre more frequently than by song title, then the state of the user interface 104 may show the image 170 (“By Genre”) in the icon 114 instead of the image 171 (“By Song”).

A description of the states of the user interface 104 is now explained with respect to the dynamic navigation feature being activated. For the explanation that follows, assume the user searches the global navigational category “Music” more frequently than other global navigational categories like “Source,” “Photos,” and “Video.” Moreover, assume that when in the category “Music,” the user prefers “My Music” more frequently than other categories like “Online Music,” “Internet Radio,” and “CD/DVD.” In addition, assume for sake of this discussion that when navigating the sub-category “My Music” the user most frequently chooses to navigate by song rather than by genre, by artist, or by source. Also, assume that when navigating music by song the user most frequently listens to song titles that start with the alphabetical letters “G-I.”

Referring back to FIG. 4, the user interface 104 shows the “Music” category (image 121) in the icon 114 that may be selectable by the user because the “Music” category is most frequently chosen by the user. The other three most frequently navigated global navigational categories (“Sources,” “Photos,” and “Video”) may be shown in the icons 113, 115, and 116 respectively. Other global navigational categories such as “Settings,” “Games,” and “Network Guide” may not be initially visible on the user interface 104 since they are less frequently selected by the user.

Referring back to FIG. 9, shown is the state of the user interface 104 after the user selects the “Music” category (FIG. 4). The user interface 104 may show the sub-category “My Music” (image 141) in the icon 114 that is selectable by the user because the “My Music” sub-category is most frequently chosen by the user. The other three most frequently navigated sub-categories (“Online Music,” “Internet Radio,” and “CD/DVD”) are shown in the icons 113, 115, and 116 respectively. Other sub-categories including “Shared Music” may not be initially visible on the user interface 104 since it is less frequently selected by the user.

Referring back to FIG. 10, the user interface 104 shows the “By Song” category (image 171) in the icon 114 that may be selectable by the user because the “By Song” category is most frequently chosen by the user. The other three most frequently navigated sub-categories (“By Genre,” “By Artist,” and “By Source”) may be shown in the icons 113, 115, and 116 respectively. Other sub-categories of “My Music” may not be initially visible on the user interface 104 since they are less frequently selected by the user.

Referring back to FIG. 11, the user interface 104 shows the “G-I” alphabetical category (image 202) in the icon 114 that may be selectable by the user because song titles starting with alphabetical letters “G-I” are most frequently chosen by the user. Alphabetical categories adjacent to “G-I” (“D-F,” “J-L,” and “M-O”) may be shown in the icons 113, 115, and 116 respectively. Other navigational alphabetical categories such as “A-C and “P-R” may not be initially visible on the user interface 104 since they are less frequently selected by the user.

Now referring to FIG. 15, illustrated is a flowchart of a method 340 that may be implemented in the system of FIG. 1. The DMA 33 (FIG. 2) may implement the method. For example, the method 340 begins at block 345. The method 340 then proceeds to block 350 where the DMA 33 processes an input received by a user. The method 340 continues to block 355 where the DMA 33 receives content from a content source. Thereafter, the method 340 advances to block 360. At block 360 the DMA 33 manipulates the content in a form so that it can be transmitted to a display. The method than goes to block 365 where the DMA 33 presents a user interface on the display. The user interface is operable to allow the user to navigate the content. The method then continues to block 370 where the DMA 33 dynamically changes the user interface as at least one of an amount of content changes or the frequency of selecting content by the user changes.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof. For example, an alternative embodiment of the user interface is implemented on a mobile device such as a mobile wireless communication device. In that regard, features of the user interface discussed above allow the user to access content from various sources and easily navigate through that content.

What is claimed is:

1. An apparatus comprising:
a communication interface for receiving content from a content source;
a display interface for coupling to a display;
a processor for manipulating the content in a form so that it can be transmitted over the display interface and presented on the display;
a memory coupled to the processor for storing instructions to implement a user interface, the user interface being operable for navigating the content;
a user input section for receiving input from a user; and
wherein the processor is operable to present the user interface on the display and dynamically change the user interface as at least one of an amount of content changes or the frequency of selecting content by the user changes.

2. The apparatus of claim 1,
wherein the user interface presents content in a plurality of categories and includes a portion of a carousel having a plurality of visual cues corresponding to respective categories of the content;
wherein the user interface includes a first group of visible visual cues in a first state of the user interface, and a second group of visible visual cues in a second state of the user interface, each of the first and second groups of visible visual cues including at least one visual cue that is free from the other group; and
in response to user input received by the user input section, the processor is operable to change the state of the user interface between the first and second states so that one of the visual cues in the first group is free from being presented on the display.

3. The apparatus of claim 2,
wherein in response to user input the processor is operable to present a scrolling feature on the display, the scrolling feature having a first group of visual scrolling cues in a first state of the scrolling feature and a second group of visual scrolling cues in a second state of the scrolling feature, the first and second groups of visual scrolling cues corresponding to the plurality of visual cues on the user interface; and
wherein in response to user input the processor is operable to change between the first and second states of the scrolling feature so that: the change in state of the scrolling feature appears continuous, and the first and second groups of visual scrolling cues are presented in a looping manner.

4. The apparatus of claim 2 wherein the frequency of selecting content by the user includes the frequency at which the plurality of visual cues are selected by the user.

5. The apparatus of claim 4 wherein dynamically changing the user interface as the frequency of selecting content by the user changes includes presenting a third group of visible visual cues on the user interface that correspond to categories that are most frequently selected by the user.

6. The apparatus of claim 2, wherein dynamically changing the user interface in response to the amount of content includes changing the number of visual cues corresponding to a respective category depending upon the amount of content in the respective category.

7. The apparatus of claim 6, wherein dynamically changing the user interface in response to the amount of content includes changing the number of visual cues in direct proportion to the amount of content in the respective category.

8. An apparatus comprising:
a tangible computer-readable storage structure storing a computer program that, when executed:
processes an input received by a user;
receives content from a content source;
manipulates the content in a form so that it can be transmitted to a display;
presents a user interface on the display, the user interface operable to allow the user to navigate the content; and
dynamically changes the user interface as at least one of an amount of content changes or the frequency of selecting content by the user changes.

9. The apparatus of claim 8,
wherein the user interface includes:
a plurality of categories of the content;
a portion of a carousel having a plurality of visual cues corresponding to respective categories of the content; and
a first group of visible visual cues in a first state of the user interface, and a second group of visible visual cues in a second state of the user interface, each of the first and second groups of visual cues including at least one visual cue that is free from the other group; and
wherein the computer program when executed further responds to user input and changes the state of the user interface from the first state to the second state so that one of the visual cues in the first group is free from being presented on the display and a visual cue different from each of the visual cues in the first group is presented on the display.

10. The apparatus of claim 9 wherein the frequency of selecting content by the user includes the frequency at which visual cues are selected by the user.

11. The apparatus of claim 10 wherein dynamically changing the user interface as the frequency of selecting content by the user changes includes presenting a third group of visible visual cues on the user interface that correspond to categories of the content that are most frequently selected by the user

12. The apparatus of claim 9, wherein dynamically changing the user interface in response to the amount of content includes changing the number of visual cues corresponding to a respective category depending upon the amount of content in the respective category.

13. The apparatus of claim 12, wherein dynamically changing the user interface in response to the amount of content includes changing the number of visual cues in direct proportion to the amount of content in the respective category.

14. The apparatus of claim 9, wherein the computer program when executed:
presents a scrolling feature on the display, the scrolling feature having a first group of visual scrolling cues in a first state of the scrolling feature and a second group of visual scrolling cues in a second state of the scrolling feature, the first and second groups of visual scrolling cues corresponding to the plurality of visual cues on the user interface; and
in response to user input changes between the first and second states of the scrolling feature so that: the change in state of the scrolling feature appears continuous, and the first and second groups of visual scrolling cues are presented in a looping manner.

15. An apparatus comprising:
a communication interface for receiving content from a content source;
a display interface for coupling to a display;
a processor for manipulating the received content in a form so that it can be transferred by the display interface to the display for presentation on the display;
a user input section for receiving input from a user;
a memory coupled to the processor for storing instructions that are operated by the processor to present a user interface on the display, the user interface being operable for navigating the content from the content source;
wherein in a first operational state the user interface includes a portion of a carousel that is bound by first and second arcs, one of the first and second arcs having a radius that is greater than the other of the first and second arc, the portion of the carousel being visibly present on the display and having a plurality of visual cues for navigating the content from the source, and wherein in a second operational state the user interface includes a second portion of the carousel that is visibly present on the display, the second portion including a subset of the first portion and being bound by a side of the display and one of the first and second arcs; and
wherein in response to user input received by the interface, the processor is operable to change between the first and second operational states of the user interface that is presented on the display.

16. The apparatus of claim 15, wherein the processor is operable to dynamically change the user interface as the frequency of selecting content by the user changes.

17. The apparatus of claim 15, wherein the processor is operable to dynamically change the user interface as an amount of content changes.

18. The apparatus of claim 15, wherein in the first operational state the processor is operable to translate the visual cues around the portion of the carousel in a manner so that it appears that some of the visual cues are shifted off of the portion of the carousel and additional visual cues are shifted onto the portion of the carousel.

19. The apparatus of claim 18, wherein the user interface includes a stationary position that illuminates one of the visual cues that can be selected by the user for navigating a category of content that corresponds to the selected visual cue.

20. The apparatus of claim 18, wherein in response to the user selecting one of the visual cues in the stationary position, the processor is operable to refresh the visual cues on the portion of the carousel visibly present on the display with sub-categorical visual cues that correspond to the selected visual cue.

21. The apparatus of claim 20, wherein the processor is operable to refresh the visual cues on the portion of the carousel visibly present on the display with a number of sub-categorical visual cues depending upon the amount of content in the category that is selected.

22. The apparatus of claim 15, wherein in one of the first and second operational states the processor is operable to:
present a scrolling feature on the display, the scrolling feature having a first group of visual scrolling cues in a first state of the scrolling feature and a second group of visual scrolling cues in a second state of the scrolling feature, the first and second groups of visual scrolling cues corresponding to the plurality of visual cues on the user interface; and
in response to user input the processor change between the first and second states of the scrolling feature so that: the change in state of the scrolling feature appears continuous, and the first and second groups of visual scrolling cues are presented in a looping manner.

23. A method comprising
processing an input received by a user;
receiving content from a content source;
manipulating the content in a form so that it can be transmitted to a display;
presenting a user interface on the display, the user interface operable to allow the user to navigate the content; and
dynamically changing the user interface as at least one of an amount of content changes or the frequency of selecting content by the user changes.

24. The method of claim 23, wherein presenting a user interface on the display includes
presenting on the display a plurality of categories of the content;
presenting on the display a portion of a carousel having a plurality of visual cues corresponding to respective categories of the content; and
presenting on the display a first group of visible visual cues in a first state of the user interface, and a second group of visible visual cues in a second state of the user interface, each of the first and second groups of visual cues including at least one visual cue that is free from the other group; and
in response to user input changing the state of the user interface that is being presented on the display from the first state to the second state so that one of the visual cues in the first group is free from being presented on the display and a visual cue different from each of the visual cues in the first group is presented on the display.

25. The method of claim 24, wherein the frequency of selecting content by the user includes the frequency at which the plurality of visual cues are selected by the user.
